(19) United States
(12) Patent Application Publication
(10) Pub. No.: US 2002/0019917 A1
(43) Pub. Date: Feb. 14, 2002

(54) Data transfer apparatus and microcomputer

(76) Inventors: Yoshinori Teshima, Toyota-shi (JP); Hiroshi Fujii, Aichi-ken (JP); Hideaki Ishihara, Okazaki-shi (JP)

Correspondence Address: LAW OFFICE OF DAVID G POSZ, 2000 L STREET, N.W., SUITE 200, WASHINGTON, DC, 20036, US

(21) Appl. No.: 09/897,415

(22) Filed: Jul. 3, 2001

(30) Foreign Application Priority Data
Jul. 5, 2000 (JP) 2000-203785

(51) Int. Cl. G06F 13/28

(52) U.S. Cl. 711/161; 711/219; 710/22

(57) ABSTRACT

A selective output circuit of a DMA controller selectively outputs either an address change amount relevant to the transfer data size or an address change amount independent of the transfer data size to a second input port of an adder with reference to settings of control register. The adder has a first input port for receiving an address value being set in a source address register and a second input port for receiving the selected address change amount, and is arranged so as to output a summed-up result to the source address register.

### BACKGROUND OF THE INVENTION

The present invention relates to a data transfer apparatus which transfers data stored in a memory of a source device to a memory of a destination device according to the settings of a processor (CPU), and relates to a microcomputer incorporating this kind of data transfer apparatus.

In general, a microcomputer comprises CPU serving as a main component and peripheral circuits such as a read only memory (ROM) and a random access memory (RAM) both serving as memories, a timer, and a serial interface. CPU accesses control registers and data registers incorporated in the peripheral circuits according to a control program stored in ROM, thereby controlling the peripheral circuits.

The performance of the microprocessor is variable depending on the processing ability of CPU and the scale of peripheral circuits. The larger the scale of peripheral circuits is, the larger the size of the control program in CPU becomes. The scale (capacity) of related memories becomes large too. As a result, the processing load of CPU increases.

In such a case, a direct memory access (DMA) controller is used to reduce the processing load of CPU. More specifically, CPU sets a data source address, a destination address, a transfer data size and a transfer repeat count, and sends the setting data to the DMA controller. According to the setting data, the DMA controller reads the data of the designated source address and writes the readout data into the destination address. The transfer operation is continuously repeated by successively incrementing or decrementing the transfer address until the repetition number becomes equal to the transfer repeat count.

Namely, instead of relying on CPU, the DMA controller uses a hardware to transfer the data from the source device to the destination device. In other words, the DMA controller is different from CPU in that the data transfer operation is performed without relying on the control program. The data transfer operation can be accomplished speedily. This makes it possible to reduce an overall size of the control program by the degree corresponding to the speed-up in the data transfer operation.

According to the conventional DMA controller, the address change amount in continuous data transfer operations is automatically determined in accordance with the transfer data size being set by CPU. More specifically, when the transfer data size is 8 bits (=1 byte), the address change amount is automatically set to “±1.” When the transfer data size is 16 bits (=1 word), the address change amount is set to “±2.” When the transfer data size is 32 bits (=1 long word), the address change amount is set to “±4.”

It is now assumed that the control register existing in a source device has a 32-bit configuration with addresses dissected or located according to long word boundaries, and also assumed that the data to be transferred is only the lower 16-bit data (i.e., D0, D1, D2, - - - ) among the data contained in the continuous address regions of this register. In this case, if the transfer data size is set to 16 bits, the address change amount of the transfer address will be automatically set to “±2” by DMA controller.

As shown in a timing diagram of FIG. 9, the conventional DMA transfer operation transfers not only the required lower 16-bit data D0, D1, D2, - - - but also the upper 16-bit data D0′, D1′, - - - which are unnecessary. As a result, the data transfer operation takes a relatively long time and becomes inefficient.

### SUMMARY OF THE INVENTION

To solve the above-described problems, an object of the present invention is to provide a data transfer apparatus capable of effectively transferring only the necessary data. Another object of the present invention is to provide a microcomputer incorporating such an effective data transfer apparatus.

To accomplish the above and other related objects, the present invention provides a data transfer apparatus which transfers data stored in a memory of a source device to a memory of a destination device according to settings of a processor, wherein an address change amount during continuous data transfer operations is arbitrarily set independent of a transfer data size.

When it is not necessary to transfer all of the data existing in continuous address regions in the memory of the source device, the present invention sets the transfer address change amount independent of the transfer data size, thereby effectively transferring only the required data. In this invention, “memory” is a conceptual term including all of storage media capable of storing data. In this respect, “memory” of the present invention includes a register.

Furthermore, according to a preferable embodiment of the present invention, the data transfer apparatus comprises address setting means for designating a memory address of the source device and a memory address of the destination device, transfer setting means for setting control parameters required in the data transfer operation, an adder having a first input port for receiving an address value being set in the address setting means and a second input port for receiving the address change amount, arranged so as to output a summed-up result of two input values of the first and second input ports to the address setting means at every data transfer cycle, and selective output means for selectively outputting either an address change amount relevant to the transfer data size or an address change amount independent of the transfer data size to the second input port of the adder with reference to settings of the transfer setting means.

According to this arrangement, after a head address of the source device or a head address of the destination device is set as initial values to the address setting means, the address change amount produced from the selective output means is successively added by the adder. Accordingly, the data transfer apparatus of this invention not only changes the transfer address according to the transfer data size in a manner like the prior art but also makes it possible to change the transfer address independent of the transfer data size.

Furthermore, it is preferable that an address change amount of the source device and an address change amount of the destination device are independently set.

According to this arrangement, the data being partly or randomly read out of the source device can be stored the destination device so that the readout data can be disposed or relocated in continuous address regions. The data transfer pattern can be flexibly set.

The present invention provides a microcomputer incorporating the above-described data transfer apparatus, together with CPU, the source device, and the destination device. Improving the data transfer efficiency of the data transfer apparatus leads to improvement of the overall performance of microcomputer.

### BRIEF DESCRIPTION OF THE DRAWINGS

The above and other objects, features and advantages of the present invention will become more apparent from the following detailed description which is to be read in conjunction with the accompanying drawings, in which:

FIG. 1 is a block diagram showing an essential arrangement of a DMA controller in accordance with a preferred embodiment of the present invention;

FIG. 2 is a block diagram showing a detailed arrangement of the DMA controller in accordance with the preferred embodiment of the present invention;

FIG. 3 is a diagram showing a bit configuration of a control register in accordance with the preferred embodiment of the present invention;

FIG. 4 is a functional block diagram showing a schematic arrangement of a microcomputer in accordance with the preferred embodiment of the present invention;

FIG. 5 is a flowchart showing the settings in DMA controller and execution of a DMA transfer operation in accordance with the preferred embodiment of the present invention;

FIG. 6A is a block diagram showing the DMA controller and CPU which perform handshake processing in response to an interrupt request in accordance with the preferred embodiment of the present invention;

FIG. 6B is a timing diagram showing the handshake processing performed between the DMA controller and CPU immediately before starting a DMA transfer operation in accordance with the preferred embodiment of the present invention;

FIG. 7 is a time diagram showing details of a DMA transfer operation performed by DMA controller in accordance with the preferred embodiment of the present invention;

FIG. 8 is a conceptional diagram showing an address configuration of a control register in a source device dissected according to long word boundaries; and FIG. 9 is a timing diagram showing a conventional transfer operation.

### DESCRIPTION OF THE PREFERRED EMBODIMENT

A preferred embodiment of the present invention will be explained hereinafter with reference to attached drawings. Identical parts are denoted by the same reference numerals throughout the drawings.

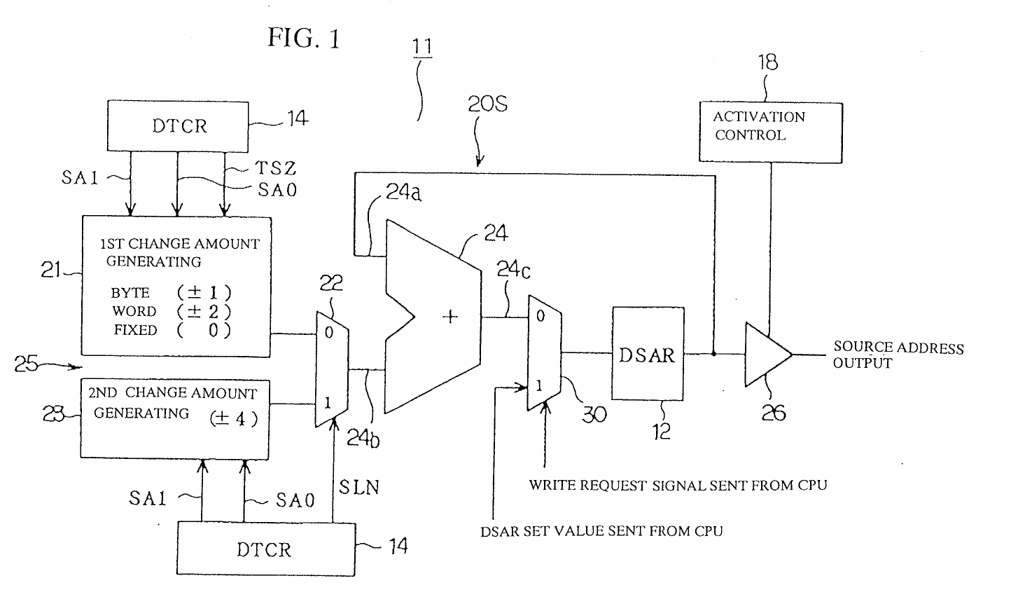

Hereinafter, a data transfer apparatus according to a preferred embodiment of the present invention will be explained with reference to FIGS. 1 to 7.

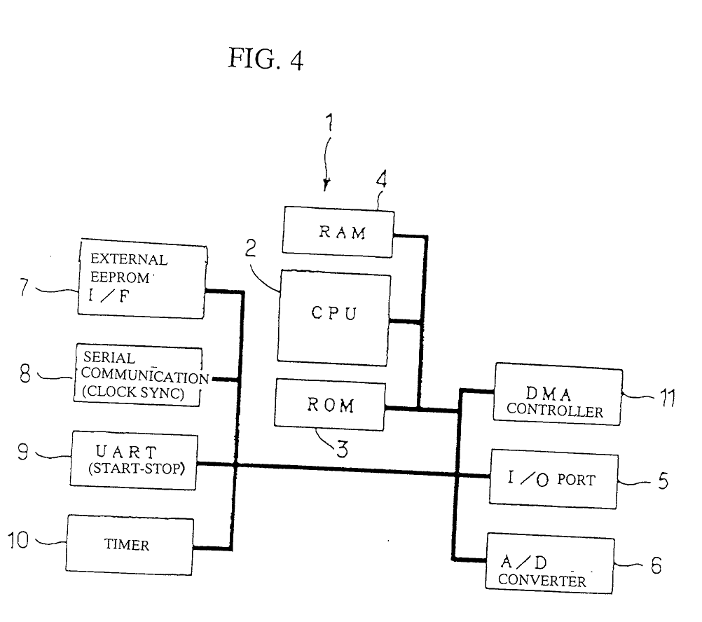

FIG. 4 is a functional block diagram showing a schematic arrangement of microcomputer 1.

Microcomputer 1 comprises processor (i.e., CPU) 2 as a main component, ROM 3 storing control programs, and RAM 4 used as a work area. Furthermore, microcomputer 1 is associated with various peripheral devices, such as input-output (I/O) port 5, analog-digital (A/D) converter 6, electrically erasable and programmable ROM (EEPROM) interface (I/F) 7, serial communication circuit 8, universal asynchronous receiver transmitter (UART) 9, timer 10, and direct memory access (DMA) controller 11.

I/O port 5 allows CPU 2 to input and output digital data from and to an external device. A/D converter 6 converts analog data into digital data. EEPROM interface 7 allows CPU 2 to write or read data to and from an external EEPROM (not shown).

Serial communication circuit 8 is used for the synchronous serial communication performed between CPU 2 and an external device. Similarly, UART 9 (start-stop type) is used for the asynchronous serial communication performed between CPU 2 and an external device. Timer 10 cyclically generates a timer interrupt which is sent to CPU 2.

DMA controller 11, serving as a data transfer apparatus, controls data transfer operations performed between RAM 4 and built-in memories or control registers of the peripheral devices (except timer 10), or performed between RAM 4 and peripheral devices themselves, with reference to the settings determined by CPU 2. According to this embodiment, CPU 2 has a data bus size of 16 bits.

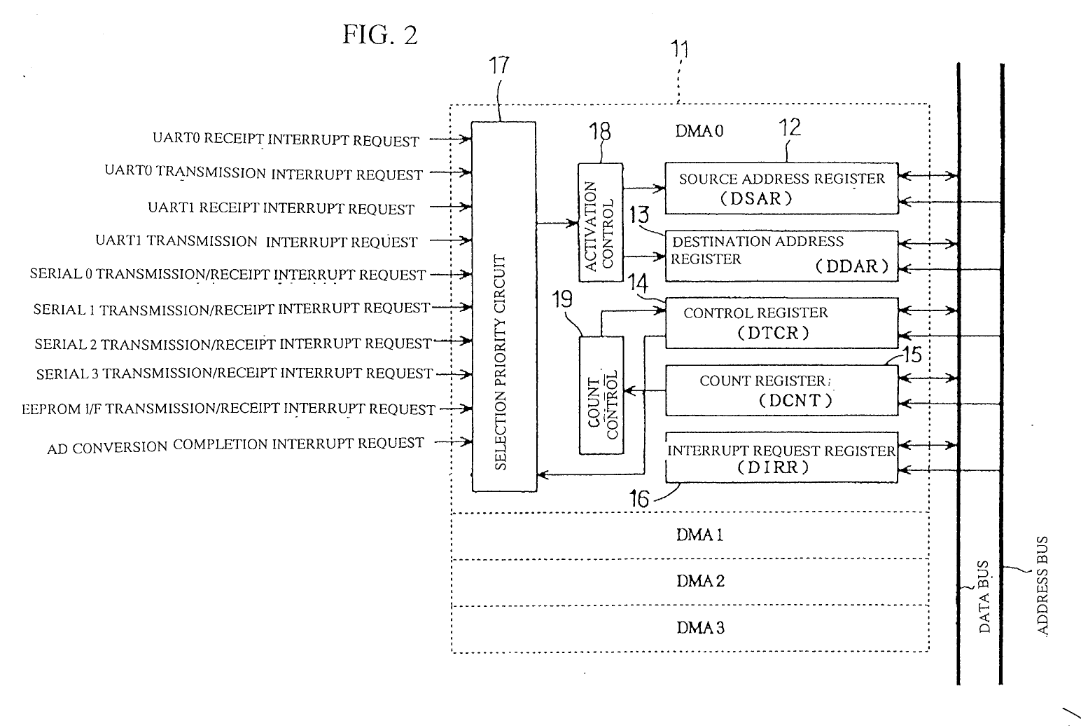

FIG. 2 is a functional block diagram showing an internal arrangement of DMA controller 11 which comprises a total of five registers; i.e., source address register (DSAR) 12, destination address register (DDAR) 13, control register (DTCR) 14, count register (DCNT) 15, and interrupt request register (DIRR) 16.

To perform DMA transfer operations, DSAR 12 and DDAR 13 cooperatively function as an address setting means. More specifically, DSAR 12 sets a source address (i.e., an address of a source device which stores data to be transferred) and DDAR 13 sets a destination address (i.e., an address of a destination device which stores the data received from the source through the DMA transfer operation). DTCR 14 serves as a transfer setting means for setting control parameters used in a DMA transfer operation. DCNT 15 sets a transfer count for the DMA transfer operation. DIRR 16 controls receipt of various interrupt requests entered in DMA controller 11 during transferring operations. When a DMA transfer operation is finished ordinarily, “1” is set to #0 bit (DIR) by hardware.

Selection priority circuit 17, connected to CPU 2 and to the peripheral devices, input various interrupt requests, such as UART0 receipt interrupt request, UART0 transmission interrupt request, UART1 receipt interrupt request, UART1 transmission interrupt request (0 and 1 respectively represents the channel of UART), serial 0 transmission/receipt interrupt request, serial 1 transmission/receipt interrupt request, serial 2 transmission/receipt interrupt request, serial 3 transmission/receipt interrupt request, and EEPROM_I/F transmission/receipt. Selection priority circuit 17 accepts only the interrupt request agreeing with the setting of DTCR 14. Each interrupt request received by selection priority circuit 17 is sent to activation control section 18.

Activation control section 18 causes DSAR 12 and DDAR 13 to output respective addresses being set currently to an address bus of microcomputer 1, thereby starting a DMA transfer operation. Count control section 19 performs a count control of DMA transfer operation based on a repeat count being set in DCNT 15. The control result is reflected to bit data of DTCR 14. An address value being set in DCNT 15 is successively incremented or decremented by count control section 19. When the address value is decreased to “0”, the DMA transfer operation is terminated.

The above-described components 12-19 cooperatively constitute each channel of DMA controller 11. DMA controller 11 has a plurality of channels (e.g., four channels of “DMA0” to “DMA3”). The setting of each channel can be performed independently.

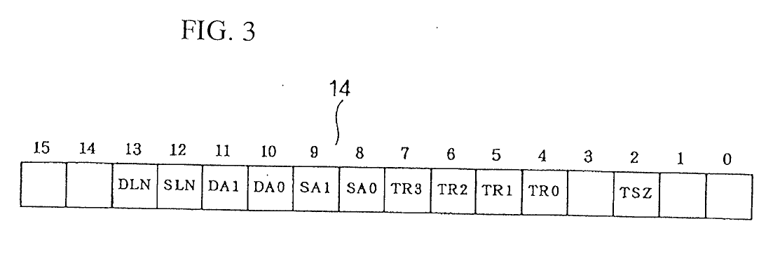

FIG. 3 shows a 16-bit configuration of DTCR 14. According to this bit configuration, #13 bit (DLN) is used to set an increment/decrement amount (i.e., change amount) of destination address. When DLN is set to 0 (i.e., DLN=0), the change amount of destination address is a value dependent on a transfer data size being set by other bit. Namely, when the transfer data size is 8 bit (=byte), the change amount of destination address is set to “±1.” When the transfer data size is 16 bit (=word), the change amount of destination address is set to “±2.”

When DLN is set to 1, the change amount of destination address is fixed to “±4” regardless of transfer data size.

Meanwhile, #12 bit (SLN) is used to set a change amount of source address in the same manner as that of destination address.

Next, #11 and #10 bits (DA1, DA0), whose binary values provide a total of four combinations, are used to discriminate four states of “fixed”, “increment”, “decrement”, and “disabled” for the destination address. Similarly, #9 and #8 bits (SA1, SA0) are used to discriminate four states of “fixed”, “increment”, “decrement”, and “disabled” for the source address.

Next, #7, #6, #5 and #4 bits (TR3, TR2, TR1, TR0) are used to select the factor of DMA transfer request. As described previously, each of channels DMA0 to DMA3 of DMA controller 11 is activated in response to a predetermined factor among the above-described various interrupt requests entered in selection priority circuit 17. Thus, #7, #6, #5 and #4 bits cooperatively set the activation factor for a corresponding channel. For example, when the activation factor is set to “0000B(binary)”, this channel is activated in response to the UART0 receipt interrupt request. When the activation factor is set to “0001B”, this channel is activated in response to the UART0 transmission interrupt request.

Next, #2 bit (TSZ) is used to set a transfer data size of DMA transfer operation. When TSZ is 0 (i.e., TSZ=0), the transfer data size is set to 1 byte (=8 bits). When TSZ is 1 (i.e., TSZ=1), the transfer data size is set to 1 word (=16 bits).

Although not shown, DTCR 14 performs setting relating to a transfer mode of burst/cycle steal (single) etc as well as enabling/disabling of transfer.

FIG. 1 shows an arrangement of source address output circuit 20S of DMA controller 11. First change amount generating section 21 obtains a change amount of the transfer address so as to correspond to the transfer data size with reference to the settings of SA1, SA0 and TSZ of DTCR 14, and outputs the obtained change amount to an input port “0” of multiplexer 22. More specifically, first change amount generating section 21 outputs ±1 when the transfer data size is 1 byte, and outputs ±2 when the transfer data size is 1 word. However, when the settings of SA1 and SA0 designate the “fixed” state, the change amount of the transfer address is set to “0” irrespective of transfer data size (i.e., TSZ value in #2 bit). Thus, the source address is fixed.

Second change amount generating section 23 always sets a change amount of the transfer address to a predetermined value (e.g., ±4), and outputs the obtained change amount to an input port “1” of the multiplexer 22.

The multiplexer 22 selects either one of the change amounts entered into its input ports “0” and “1” with reference to the setting of SLN of DTCR 14, and outputs the selected change amount to second input port 24b of adder 24.

More specifically, when SLN is 0 (i.e., SLN=0), the multiplexer 22 selects the change amount entered in the input port “0.” When SLN is 1 (i.e., SLN=1), the multiplexer 22 selects the change amount entered in the input port “1.” The first change amount generating section 21, second change amount generating section 23 and multiplexer 22 cooperatively constitute selective output circuit 25.

The adder 24 has output port 24c connected to an input port “0” of multiplexer 30. The multiplexer 30 has an output port connected to the address bus of microcomputer 1 via DSAR 12 and output buffer 26. DSAR 12 has an output terminal connected to first input port 24a of adder 24.

Multiplexer 30 has an input port “1” which receives a source address setting value sent from CPU 2. The data given to the input port “1” is selected in response to a write request signal sent from CPU 2 to multiplexer 30. Before starting a DMA transfer operation, CPU2 sets a source address to DSAR 12. However, during the DMA transfer operation, multiplexer 30 selects the data entered from its input port “0” so that an output of adder 24 can be successively set in DSAR12. Adder 24 receives an output data of DSAR 12 at its first input port 24a as well as an output data of multiplexer 22 at its second input port 24b, and sends a summed-up value of two input data to DSAR 12 at every DMA transfer cycle.

Activation control section 18 performs an enable control for output buffer 26.

Although not shown, DMA controller 11 has a destination address output circuit which has substantially the same arrangement as that of the above-described source address output circuit 20S. It is needless to say that SA1, SA0 and SLN produced from DTCR 14 are replaced with DA1, DA0 and DLN. Furthermore, DSAR 12 is replaced with DDAR 13.

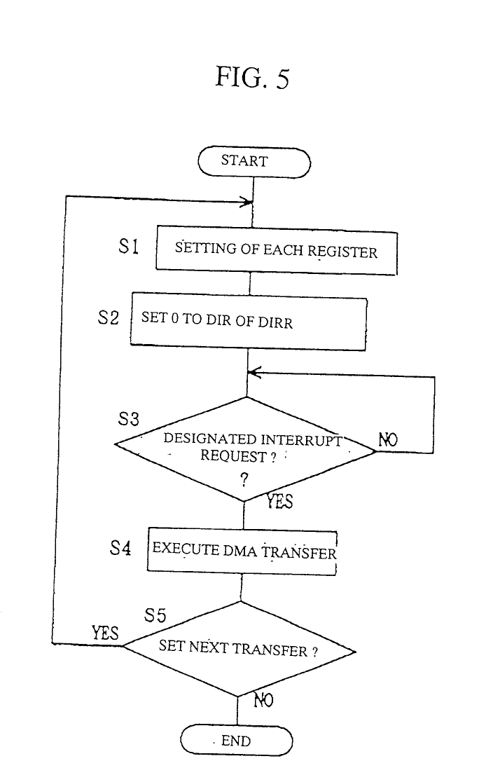

Next, function of this embodiment will be explained with reference to FIGS. 5 to 7.

FIG. 5 is a flowchart showing the settings in DMA controller 11 and execution of a DMA transfer operation. First, CPU 2 performs the settings required for respective registers DSAR 12, DDAR 13, DTCR 14 and DCNT 15 (in step S1). The settings in step S1 include designation of source address, destination address, transfer data size, address increment/decrement with change amount, and transfer request factor.

Next, CPU 2 sets DIR of DIRR16 to “0” (in step S2) and waits for a while until an interrupt request caused from the factor designated in step S1 is generated (in step S3). Then, when the designated interrupt request is generated (i.e., YES in step S3), DMA controller 11 performs a DMA transfer operation (in step S4). When the DMA transfer operation is completed ordinarily, “1” is set to DIR of DIRR 16 by hardware. Subsequently, when the setting of the next DMA transfer operation is required (i.e., YES in step S5), the control flow returns to step S1. On the other hand, when no setting for the next DMA transfer operation is required (i.e., NO in step S5), this routine is terminated.

The intent to set DIR of DIRR 16 to “0” in step S2 is to reset the DIR value before starting each DMA transfer operation considering the fact that DIR is set to “1” when the DMA transfer operation is completed ordinarily. This resetting operation makes it possible to receive the next generating interrupt request.

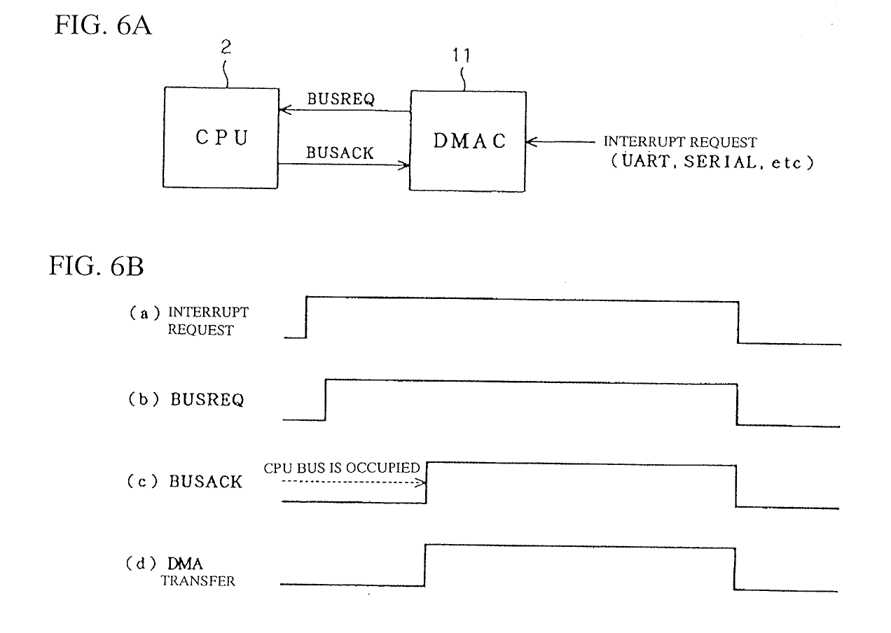

FIG. 6B is a timing diagram showing the handshake processing performed between DMA controller 11 and CPU 2 (refer to FIG. 6A) immediately before starting a DMA transfer operation (i.e., YES in step S3). When the designated interrupt request is entered (refer to FIG. 6B(a)), DMA controller 11 outputs a bus request signal BUSREQ to CPU 2 (refer to FIG. 6B(b)). CPU 2 returns a bus acknowledgment signal BUSACK after CPU 2 completes the current use of the bus of microprocessor 1 (refer to FIG. 6B(c)). After the bus acknowledgment signal BUSACK becomes active, DMA controller 11 starts a DMA transfer operation (refer to FIG. 6B(d)).

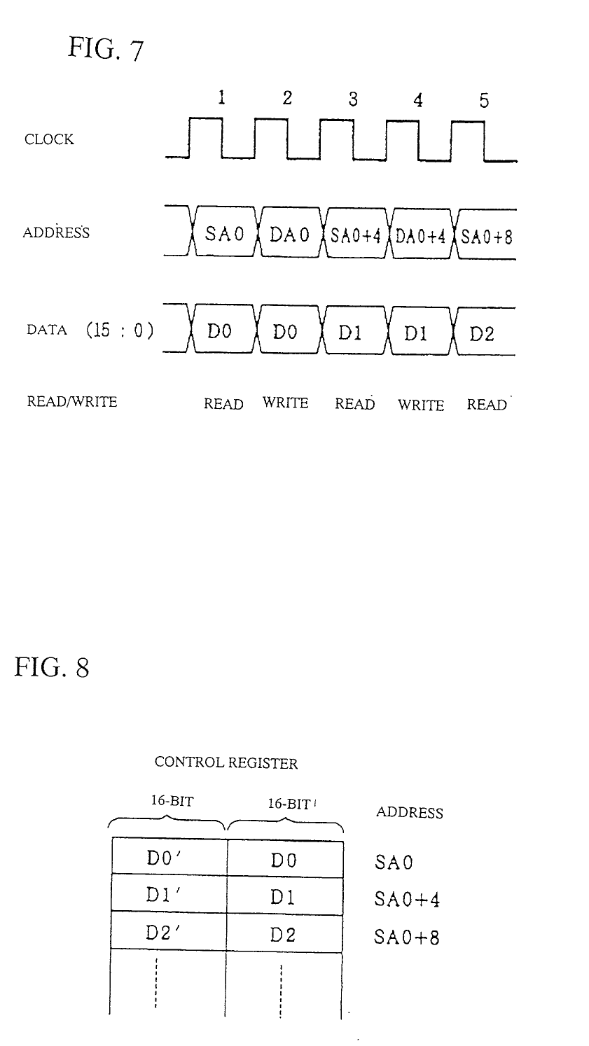

FIG. 7 is a timing diagram showing details of a DMA transfer operation performed by DMA controller 11. The transfer pattern shown in FIG. 7 is based on the settings of DLN and SLN of DTCR 14 which are both set to “1” as characteristic features of the present invention. The transfer address is set to “increment” and the transfer data size is set to a word (=16 bits). Each of the source address and the destination address is set to be increased by “4.”

As shown in FIG. 1, SLN of DTCR 14 is set to 1. Multiplexer 22 selects the output “+4” of second change amount generating section 23 and sends the selected value to input port 24b of adder 24.

For example, it is assumed that UART0 receipt interrupt request is set, the source address is SA0 indicating a control register and a receiving buffer of UART 9 (source device)/channel “0”, and also assumed that the destination address is DA0 indicating a predetermined region of RAM 4 (destination device). In this case, SA0 and DA0 are not identical with those indicating the bits of DTCR 14.

First, at clock 1, DMA controller 11 accesses address SA0 of UART 9 to read data D0. Next, at clock 2, DMA controller 11 accesses address DA0 of RAM 4 to write data D0. Next, at clock 3, DMA controller 11 accesses address (SA0+4) of UART 9 to read data D1. Next, at clock 4, DMA controller 11 accesses address (DA0+4) of RAM 4 to write data D1. Next, at clock 5, DMA controller 11 accesses address (SA0+8) of UART 9 to read data D2. In this manner, the data transfer operation is performed repetitively by the number of times equal to the repeat count being set beforehand.

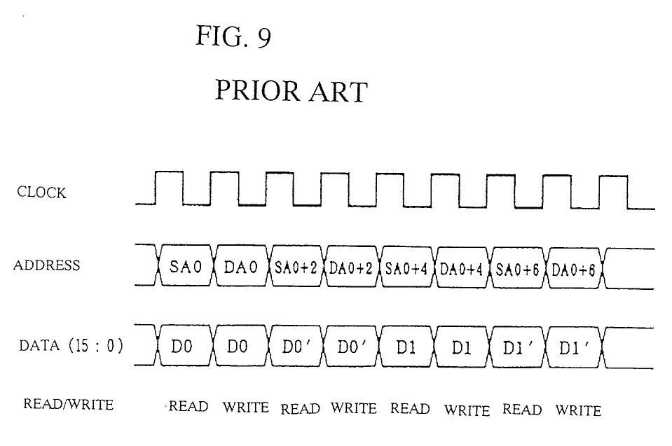

As shown in FIG. 8, among the data stored in a 32-bit register (or a 32-bit memory) located according to long word boundaries, only the lower 16-bit data D0, D1, D2, - - - can be transferred sequentially. In this case, the data transfer cycle is equivalent to two cycles of the clock signal shown in FIG. 7.

As described above, according to this embodiment, DMA controller 11 can set the address change amount during a DMA transfer operation independent of the transfer data size. Thus, it becomes possible to selectively transfer part of the data (i.e., only the required data) of the continuous address regions in the source device, thereby realizing an effective data transfer operation.

Furthermore, when the source device and peripheral circuits each serving as a destination device are expanded from 16-bit configuration to 32-bit configuration by relocating addresses according to long word boundaries, this embodiment makes it possible to realize an effective data transfer by setting the transfer address change amount independent of the transfer data size.

Furthermore, selective output circuit 25 outputs the transfer address change amount relevant to the transfer data size or the transfer address change amount independent of the transfer data size in accordance with the setting of DTCR 14. Adder 24 receives the transfer address change amount selected by selective output circuit 25 at one input port 24b and also receives the address value produced from DSAR 12 at another input port 24a. Adder 24 sums two input values at every data transfer cycle and sends the summed-up value to DSAR 12. Accordingly, this embodiment not only makes it possible to change the transfer address according to the transfer data size in a manner like the conventional art but also makes it possible to change the transfer address independent of the transfer data size.

Furthermore, as DMA controller 11 can independently set the address change amount relevant to the source device and the address change amount relevant to the destination device. Thus, it becomes possible to partly or randomly read the data from the source device and relocate the readout data in serial address regions in the destination device. Thus, the data transfer pattern can be flexibly set.

Furthermore, microcomputer 1 is constituted by integrating the source device and the destination device, including DMA controller 11, CPU 2, I/O port 5, A/D converter 6, EEPROM interface 7, serial communication circuit 8, and UART 9. Improving the data transfer efficiency of DMA controller 11 leads to improvement of the overall performance of microcomputer 1.

The present invention is not limited to the illustrated embodiment and therefore can be modified in various ways.

For example, the address change amount being set independent of the transfer data size is not limited to “±4” and therefore can be replaced by “±2” or “±8” or other appropriate value. Furthermore, the address change amount being set independent of the transfer data size is not limited to a fixed value and therefore can be replaced by a variable value, for example, varying stepwise “±2”, “±4”, “±8”, - - - according to the setting relating to bits.

Furthermore, it is possible to use a commonly value as the address change amount being set independent of the transfer data size for the source address and for the destination address.

Furthermore, an address change amount being set in the data transfer apparatus can be either an increment value or a decrement value.

The data transfer apparatus is not limited to a DMA controller incorporated in a microcomputer and therefore can be replaced by a single unit of DMA controller.

What is claimed is:

1. A data transfer apparatus which transfers data stored in a memory of a source device to a memory of a destination device according to a setting of a processor, wherein an address change amount during continuous data transfer operations is arbitrarily set independent of a transfer data size.

2. The data transfer apparatus in accordance with claim 1, further comprising:
address setting means for designating a memory address of said source device and a memory address of said destination device;
transfer setting means for setting control parameters required in the data transfer operation;
an adder having a first input port for receiving an address value being set in said address setting means and a second input port for receiving the address change amount, and being arranged so as to output a summed-up result of two input values of said first and second input ports to said address setting means at every data transfer cycle; and
selective output means for selectively outputting either an address change amount relevant to the transfer data size or an address change amount independent of the transfer data size to said second input port of said adder with reference to settings of said transfer setting means.

3. The data transfer apparatus in accordance with claim 1, wherein an address change amount of said source device and an address change amount of said destination device are independently set.

4. A microcomputer incorporating a data transfer apparatus, a processor, a source device, and a destination device, wherein said data transfer apparatus transfers data stored in a memory of said source device to a memory of said destination device according to a setting of the processor, and an address change amount during continuous data transfer operations is arbitrarily set independent of a transfer data size.
